(19) United States
(12) Patent Application Publication
(10) Pub. No.: US 2006/0258388 A1
(43) Pub. Date: Nov. 16, 2006

(54) Mobile radio terminal apparatus

(75) Inventor: Hiroyasu Sato, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/241,305

(22) Filed: Sep. 30, 2005

(30) Foreign Application Priority Data
May 16, 2005 (JP) 2005-142854

(51) Int. Cl. H04M 1/00

(52) U.S. Cl. 455/550.1

(57) ABSTRACT

Control unit stores unanswered incoming call history data in unanswered incoming call history storage area when an incoming call is received. When the incoming call is answered, the control unit deletes the unanswered incoming call history data and, instead, stores incoming call history data in incoming call history storage area. When conversation is ended, the control unit stores conversation history data in conversation history storage area.

### CROSS-REFERENCE TO RELATED APPLICATIONS

This application is based upon and claims the benefit of priority from prior Japanese Patent Application No. 2005-142854, filed May 16, 2005, the entire contents of which are incorporated herein by reference.

### BACKGROUND OF THE INVENTION

1. Field of the Invention

This invention relates to a mobile radio terminal apparatus having a function of storing history information generated in association with incoming calls, for example an incoming call history.

2. Description of the Related Art

As is well known, cellular telephones and PHS (Personal Handyphone System) terminals have a function of storing an incoming and outgoing call history generated in association with outgoing calls and incoming calls. With this function, a user can understand whom (or what places) and when the user previously made outgoing calls to and who (or what places) and when the user previously received incoming calls from.

However, a process of storing such an incoming and outgoing call history is executed after an incoming call is terminated or a telephone conversation is terminated. For this reason, if battery exhaustion, detachment of a battery, or abnormal termination of communications happen during an incoming call or during a telephone conversation, the incoming and outgoing call history is not stored.

Conventionally, in a case of reduction in the battery voltage, the history has been stored prior to the battery exhaustion (see, for example, Jpn. Pat. Appln. KOKAI Publication No. 2001-268179). However, this method cannot respond to occurrence of unexpected situations such as detachment of the battery, abnormal termination of conversations, and the like.

### BRIEF SUMMARY OF THE INVENTION

The present invention has been accomplished to solve the above-described problems. The object of the present invention is to provide a mobile radio terminal apparatus capable of storing an incoming call history even if battery exhaustion, detachment of the battery or abnormal termination of conversations occurs during an incoming call or during a telephone conversation.

To achieve the object, an aspect of the present invention is a mobile radio terminal apparatus capable of making communications with a radio base station connected to a network. The apparatus comprises time register unit configured to register time, receiving unit configured to receive an incoming call signal from the radio base station, caller detection unit configured to detect caller identification information in the incoming call signal received by the receiving unit, incoming call time detection unit for detecting time when the incoming call has been received, in accordance with the time registered by the time register unit, unanswered incoming call history storing unit configured to, if an incoming call is received, store the identification information detected by the caller detection unit and the time detected by the incoming call time detection unit as a history of an unanswered incoming call, and incoming call history storing unit configured to, if conversation is started by answering the incoming call, store the identification information detected by the caller detection unit and the time detected by the incoming call time detection unit as a history of an answered incoming call.

According to the present invention, a mobile radio terminal apparatus capable of storing an incoming call history even if battery exhaustion, detachment of the battery or abnormal termination of conversations occurs during an incoming call or during a telephone conversation, can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a block diagram of a mobile radio terminal apparatus according to an embodiment of the present invention;

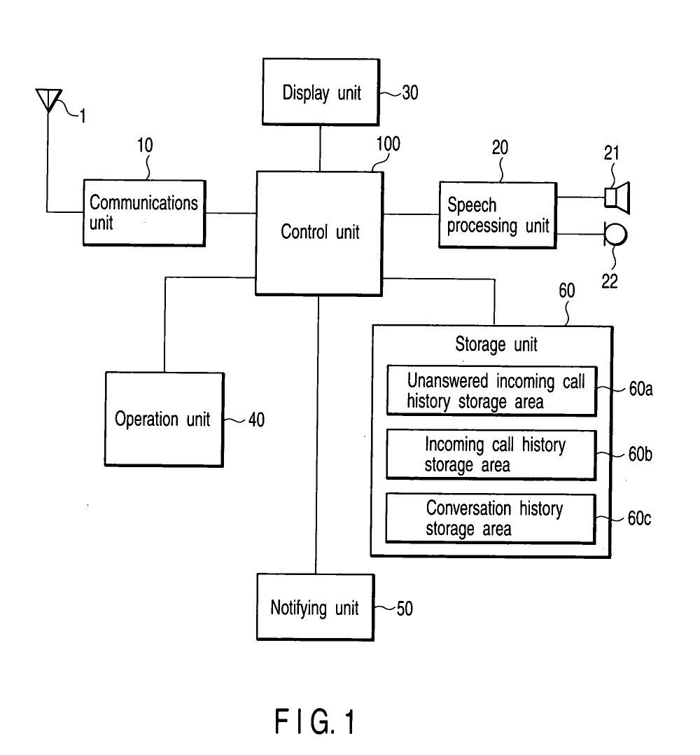

FIG. 2 shows a flowchart of operations in a case where an incoming call occurs in the mobile radio terminal apparatus shown in FIG. 1;

FIG. 3 shows illustrations of change in display of history information in the mobile radio terminal apparatus shown in FIG. 1;

FIG. 4 shows a flowchart of operations in a case where the mobile radio terminal apparatus is turned on or restarted; and

FIG. 5 shows illustrations of change in display of history information in the mobile radio terminal apparatus shown in FIG. 1.

### DETAILED DESCRIPTION OF THE INVENTION

An embodiment of the present invention will be explained below with reference to the accompanying drawings. The mobile radio terminal apparatus of this embodiment comprises an antenna 1, a communications unit 10, a speech processing unit 20, a display unit 30, an operation unit 40, a notifying unit 50, a storage unit 60 and a control unit 100.

The antenna 1 receives a radio signal transmitted from a radio base station (not shown) connected to network and transmits a radio signal from the mobile radio terminal apparatus to the radio base station.

The communications unit 10 carries out radio communications with the radio base station via the antenna 1 and also carries out communications with a communications partner station via the radio base station and the network. More specifically, the communications unit 10 acquires encoded speech data transmitted from the communications partner station by downconverting and demodulating the radio signal received by the antenna 1, and outputs the encoded speech data to the speech processing unit 20 via the control unit 100. In addition, the communications unit 10 modulates a baseband signal with encoded speech data supplied from the speech processing unit 20 via the control unit 100, generates a radio signal by upconverting the modulated baseband signal, and transmits the radio signal to the radio base station via the antenna 1.

The speech processing unit 20 reproduces a speech signal by decoding the encoded speech data demodulated by the communications unit 10, and outputs the speech signal from a built-in speaker 21. The speech transmitted from the communications partner is thereby transmitted to the user. In addition, the speech processing unit 20 generates encoded speech data by encoding a speech signal input from a built-in microphone 22 and supplies the generated encoded speech data to the communications unit 10 via the control unit 100.

The display unit 30 is a display device employing a LCD (Liquid Crystal Display) or the like, to show various kinds of visual information such as texts, images and the like to the user. The operation unit 40 comprises a plurality of key switches and accepts requests from the user. The notifying unit 50 notifies the user of generation of an incoming call by sounds.

The storage unit 60 stores telephone book data in association with control programs, control data, telephone numbers, names, and image data such as face pictures and the like. The storage unit 60 comprises an unanswered incoming call history storage area 60a where an unanswered incoming call history is stored, an incoming call history storage area 60b where an incoming call history is stored, and a conversation history storage area 60c where a conversation history is stored.

The control unit 100 controls each of the units of the mobile radio terminal apparatus. For example, the control unit 100 comprises an incoming call control function which, in a case where the communications unit 10 receives an incoming call signal from the radio base station, notifies occurrence of the incoming call by controlling the display unit 30 and notifying unit 50, and urges the communications unit 10 to transmit a signal responding to the incoming call and establishes a speech communications link, by user's response operation executed via the operation unit 40.

In addition, the control unit 100 comprises an outgoing call control function of transmitting an outgoing call to a telephone number designated by the user by controlling the communications unit 10, in response to the user's request for outgoing call made via the operation unit 40, and a communications control function of establishing a speech communications link in accordance with the outgoing call.

Moreover, the control unit 100 comprises a control function of storing history information on incoming and outgoing calls in the storage unit 60, a control function of urging the display unit 30 to display the history information in response to the user's request made via the operation unit 40, a control function of preparing an outgoing call on the basis of the history information at the start of the mobile radio terminal apparatus, and the like. In addition to these, the control unit 100 comprises a function of registering the time.

Next, operations of the mobile radio terminal apparatus having the above-explained structure are described. The following descriptions are focused on operations relating to the control of storing the history information at the incoming call. Explanations about steps of establishing a communications link with a radio base station, control to implement speech communications, registration, invocation and editing of telephone book data, and the like are omitted.

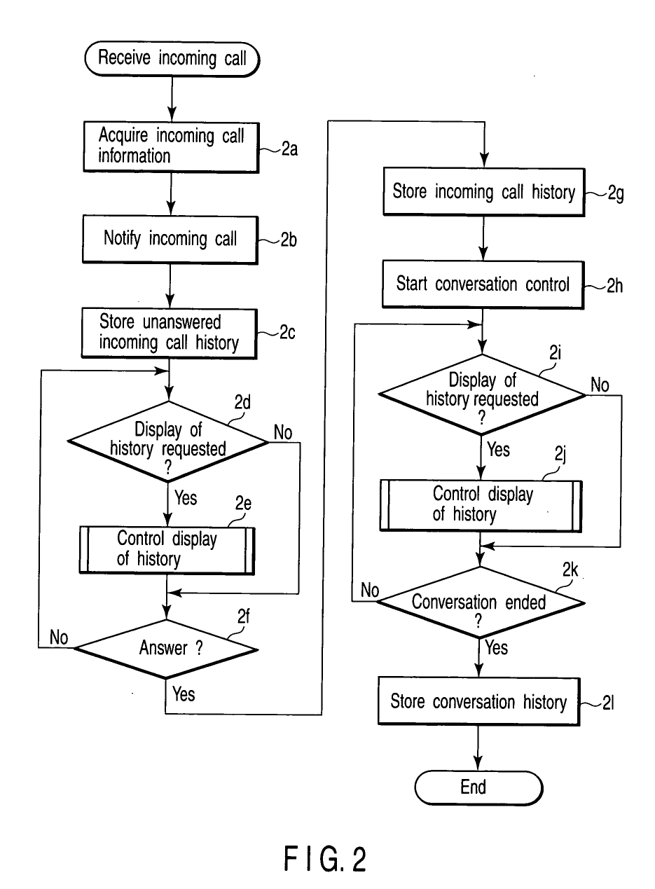

FIG. 2 is a flowchart showing the operations at the incoming call. This processing is executed by the control unit 100. A control program to implement the control shown in the flowchart is stored in the storage unit 60. This processing is started when an incoming call is received.

If an incoming call is received, the control unit 100 acquires incoming call information included in an incoming call signal from the radio base station as received by the communications unit 10, in step 2a. The control unit 100 acquires a caller's telephone number from the incoming call information, detects a current time as an incoming call reception time, and shifts to step 2b.

In step 2b, the control unit 100 controls the notifying unit 50 to output an incoming call tone and detects a name and image data corresponding to the telephone number acquired in step 2a, in the telephone book data stored in the storage unit 60. The control unit 100 controls the display unit 30 to display the detected name and image data and shifts to step 2c.

In step 2c, the control unit 100 stores the caller's telephone number and incoming call reception time detected in step 2a, and the identification information of the name and image data detected in step 2b, in association with each other, as unanswered incoming call history data, in the unanswered incoming call history storage area 60a of the storage unit 60. Then, the control unit 100 shifts to step 2d.

The unanswered incoming call history data formed in this step includes an incomplete flag. The incomplete flag added in this step is deleted by the control unit 100 if an incoming call is ended without unanswered.

In step 2d, the control unit 100 determines whether or not the user has made a request for display of the history information via the operation unit 40. If the user has made a request for display of the history information via the operation unit 40, the control unit 100 shifts to step 2e. If not, the control unit 100 shifts to step 2f.

In step 2e, the control unit 100 reads the history information in the storage unit 60 in response to the user's request made via the operation unit 40, displays the history information on the display unit 30, and shifts to step 2f. More specifically, if the user has made a request for display of the unanswered incoming call history via the operation unit 40, the control unit 100 reads the unanswered incoming call history data in the unanswered incoming call history storage area 60a, refers to the telephone book data on the basis of the unanswered incoming call history data, and displays a table of the reception time of the unanswered incoming call, caller's name, image corresponding thereto, and the like, on the display unit 30.

In addition, if the user has made a request for display of the incoming call history via the operation unit 40, the control unit 100 reads the incoming call history data in the incoming call history storage area 60b, refers to the telephone book data on the basis of the incoming call history data, and displays a table of the reception time of the answered incoming call, caller's name, image corresponding thereto, and the like, on the display unit 30.

Otherwise, if the user has made a request for display of the communications history via the operation unit 40, the control unit 100 reads the communications history data in the conversation history storage area 60c, refers to the telephone book data on the basis of the communications history data, and displays a table of the time of the communications, caller's name, image corresponding thereto, and the like, on the display unit 30.

In step 2f, the control unit 100 determines whether or not the user has made a request for answering of the incoming call via the operation unit 40. If the user has made a request for answering of the incoming call via the operation unit 40, the control unit 100 shifts to step 2g. If not, the control unit 100 shifts to step 2d.

In step 2g, the control unit 100 stores the caller's telephone number and incoming call reception time detected in step 2a, and the identification information of the name and image data detected in step 2b, in association with each other, as the incoming call history data, in the incoming call history storage area 60b of the storage unit 60. The incomplete flag is added to the incoming call history data stored in this step.

The control unit 100 deleted the unanswered incoming call history data stored in the unanswered incoming call history storage area 60a in step 2c, and shifts to step 2h. The incomplete flag added to the unanswered incoming call history data is also deleted by the control unit 100.

In step 2h, the control unit 100 establishes a communications link with the radio base station by controlling the communications unit 10, establishes a speech communications link with the communications partner station over the communications link, and starts speech communications by controlling the speech processing unit 20. The control unit 100 starts measuring the conversation time and shifts to step 2i.

In step 2i, the control unit 100 determines whether or not the user has made a request for display of the history information via the operation unit 40. If the user has made a request for display of the history information via the operation unit 40, the control unit 100 shifts to step 2j. If not, the control unit 100 shifts to step 2k.

In step 2j, the control unit 100 reads the history information in the storage unit 60 in response to the user's request made via the operation unit 40, displays the history information on the display unit 30, and shifts to step 2k. More specifically, if the user has made a request for display of the unanswered incoming call history via the operation unit 40, the control unit 100 reads the unanswered incoming call history data in the unanswered incoming call history storage area 60a, refers to the telephone book data on the basis of the unanswered incoming call history data, and displays a table of the reception time of the unanswered incoming call, caller's name, image corresponding thereto, and the like, on the display unit 30.

In addition, if the user has made a request for display of the incoming call history via the operation unit 40, the control unit 100 reads the incoming call history data in the incoming call history storage area 60b, refers to the telephone book data on the basis of the incoming call history data, and displays a table of the reception time of the answered incoming call, caller's name, image corresponding thereto, and the like, on the display unit 30.

Otherwise, if the user has made a request for display of the communications history via the operation unit 40, the control unit 100 reads the communications history data in the conversation history storage area 60c, refers to the telephone book data on the basis of the communications history data, and displays a table of the time of the communications, caller's name, image corresponding thereto, and the like, on the display unit 30.

In step 2k, the control unit 100 determines whether the user has made a request for end of the conversation via the operation unit 40 or whether or not the communications unit 10 has received a disconnection signal. If the user has made a request for end of the conversation via the operation unit 40 or if the communications unit 10 has received a disconnection signal, the control unit 100 shifts to step 21. If the user has not made the request or the communications unit 10 has not received the disconnection signal, the control unit 100 shifts to step 2i to continue the conversation control.

In step 21, the control unit 100 controls the communications unit 10 and the speech processing unit 20 to terminate the speech communications, terminate the measurement of the conversation time started in step 2h, and delete the incomplete flag added to the incoming call history data of the incoming call history storage area 60b.

The control unit 100 requires conversation charge on the basis of the conversation time, and stores the caller's telephone number and incoming call reception time detected in step 2a, the identification information of the name and image data detected in step 2b, the conversation time and the conversation charge, in association with each other, as the conversation history data, in the conversation history storage area 60c of the storage unit 60. Then the control unit 100 terminates this processing.

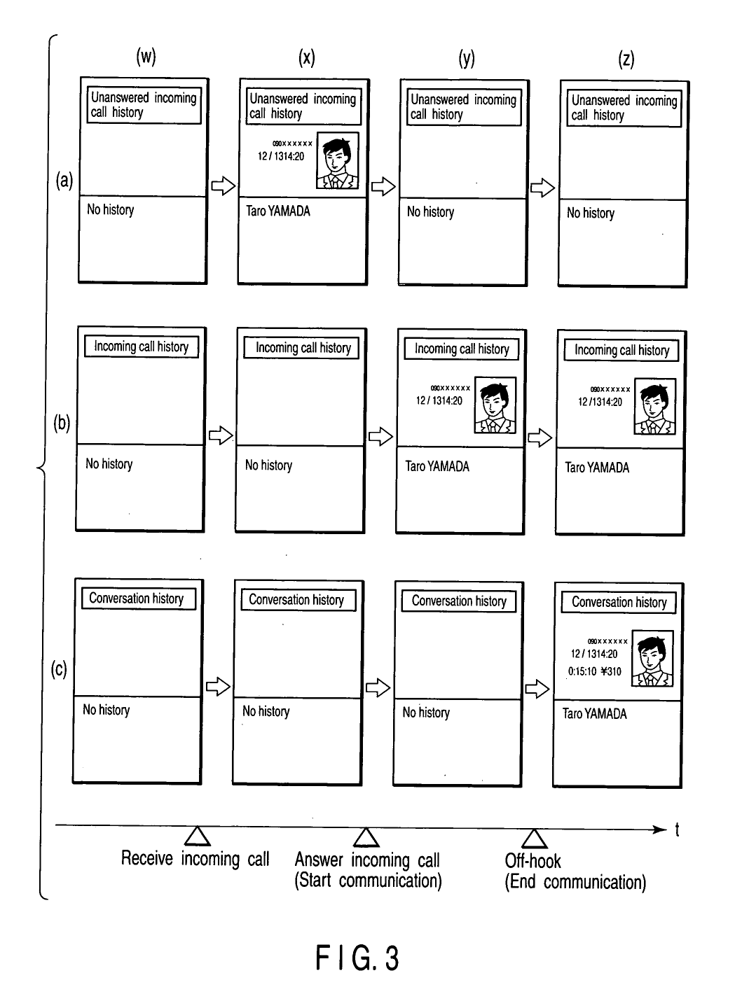

Examples of the history information displayed on the display unit 30 at the time when an incoming call is received, the time when an incoming call is answered, and the time when conversation is ended, will be described with reference to FIG. 3. FIG. 3(a) shows an example of the display in a case where the unanswered incoming call history is displayed. FIG. 3(b) shows an example of the display in a case where the incoming call history is displayed. FIG. 3(c) shows an example of the display in a case where the communication history is displayed.

For simple explanations, an incoming call is received, an incoming call is answered and conversation is ended under the condition that the history information is not stored in any one of the unanswered incoming call history storage area 60a, incoming call history storage area 60b and communications history storage area 60c.

In a case where the unanswered incoming call history is displayed, no history is displayed before an incoming call is received (w) as shown in FIG. 3(a). After that, when an incoming call is received (x), the incoming call reception date and time, caller's telephone number, and name and image corresponding thereto, are displayed since the history information is stored by the processing of step 2c. After that, when the incoming call is answered (y), no history is displayed since the unanswered incoming call history is deleted in the unanswered incoming call history storage area 60a in step 2g. The display remains unchanged after the conversation is ended (z).

In a case where the incoming call history is displayed, no history is displayed before an incoming call is received (w) and immediately after an incoming call is received (x) as shown in FIG. 3(b). After that, when the incoming call is answered (y), the incoming call reception date and time, caller's telephone number, and name and image corresponding thereto, are displayed since the incoming call history is stored in the incoming call history storage area 60b in step 2g. The display remains unchanged after the conversation is ended (z).

In a case where the conversation is displayed, no history is displayed before an incoming call is received (w), immediately after an incoming call is received (x) and after the incoming call is answered (y) as shown in FIG. 3(c). After that, when the conversation is ended (z), the incoming call reception date and time, conversation time, conversation charge, caller's telephone number, and name and image corresponding thereto, are displayed since the conversation history is stored in the conversation history storage area 60c in step 21.

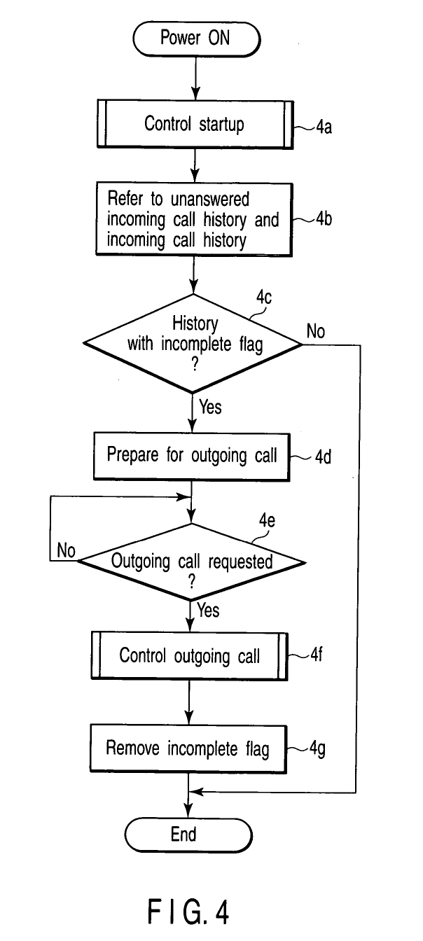

Next, operations in a case where the mobile radio terminal apparatus is turned on or restarted due to occurrence of an unexpected trouble will be described. FIG. 4 shows a flowchart of the operations at the start-up. This processing is executed by the control unit 100. A control program to carry out the control shown by this flowchart is stored in the storage unit 60. This processing is started when the terminal apparatus is turned on or restarted.

When the terminal apparatus is turned on or restarted, the control unit 100 reads the control program in the storage unit 60 to start and control each unit in step 4a. Then, the control unit 100 shifts to step 4b.

In step 4b, the control unit 100 refers to the data stored in the unanswered incoming call history storage area 60a and incoming call history storage area 60b of the storage unit 60 to search for the data to which the incomplete flag is added. Then, the control unit 100 shifts to step 4c.

In step 4c, the control unit 100 determines whether or not the data to which the incomplete flag is added is detected as a result of the search in step 4b. If the data to which the incomplete flag is added is detected, the control unit 100 shifts to step 4d. If not, the control unit 100 ends this processing and shifts to an incoming call standby state.

In step 4d, the control unit 100 detects telephone number data which is included in the data detected in step 4b, detects a name corresponding to the detected telephone number data in the telephone book data, and displays the name together with the telephone number on the display unit 30. Then, the control unit 100 shifts to step 4e.

In step 4e, the control unit 100 determines whether or not the user has made a request for outgoing call via the operation unit 40. If the user has made a request for outgoing call via the operation unit 40, the control unit 100 shifts to step 4f. If not, the control unit 100 waits for the request for outgoing call again in step 4f until a request for release is made.

In step 4f, the control unit 100 controls the communications unit 10 to make an outgoing call corresponding to the telephone number detected in step 4d. Then, the control unit 100 shifts to step 4g. If the communications unit 10 receives an answering signal for the outgoing call, the control unit 100 executes the control to establish the speech communications link.

In step 4g, the control unit 100 removes the incomplete flag detected in step 4b and ends this processing.

As described above, according to the mobile radio terminal apparatus having the above-explained structure, the unanswered incoming call history data is stored in the unanswered incoming call history storage area 60a when an incoming call is received. When the incoming call is answered, the unanswered incoming call history data is deleted and, instead, the incoming call history data is stored in the incoming call history storage area 60b. When the conversation is ended, the conversation history data is stored in the conversation history storage area 60c.

Therefore, the history information is stored at each of the times when an incoming call is received, when an incoming call is answered and when the conversation is ended. Thus, the incoming call history can be stored even if an unexpected situation such as battery exhaustion, detachment of a battery, or abnormal termination of communications happens during an incoming call or during a telephone conversation.

In addition, when the history information is stored, an incomplete flag is added to the history information. Thus, if an unexpected situation such as battery exhaustion, detachment of a battery, or abnormal termination of communications happens during an incoming call or during a telephone conversation, the incomplete flag is left in the unanswered incoming call history data or incoming call history data.

If the history data to which the incomplete flag is added exists when the mobile radio terminal apparatus is turned on, the terminal apparatus prepares for outgoing call for the telephone number to which the incomplete flag is added. Therefore, even if an unexpected situation happens and an incoming call or conversation is thereby ended, the user can make an outgoing call in reply to the incoming call. Thus, the terminal apparatus has much convenience.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above-described embodiment, if an incoming call is received, the incoming call is stored as the unanswered incoming call history data. After that, if the incoming call is answered, the unanswered incoming call history data is deleted and, instead, the incoming call history data is stored.

It is assumed that, for example, the unanswered incoming call history storage area 60a stores number n of unanswered incoming call history data items. The oldest data is deleted just when the unanswered incoming call history data is stored. After that, the latest unanswered incoming call history data item is deleted in accordance with answering for the incoming call. At this time, number n-1 of unanswered incoming call history data items are stored.

To store number n of unanswered incoming call history data items at any time, a preliminary region is provided in the storage unit 60 to temporarily store the oldest data. If an incoming call is received, the control unit 100 stores the latest incoming call as the unanswered incoming call history data item after temporarily storing the oldest data in the preliminary region.

After that, if the incoming call is answered, the control unit 100 deletes the latest unanswered incoming call history data item and stores the data stored in the preliminary region, instead, as the latest unanswered incoming call history data item. Under such control, number n of unanswered incoming call history data items can be stored at any time.

Moreover, the incoming call history and the conversation history are managed separately by providing the incoming call history storage area 60b and conversation history storage area 60c in the storage unit 60. Instead of this, however, for example, the conversation history may be managed by the incoming call history storage area 60b, without providing the conversation history storage area 60c.

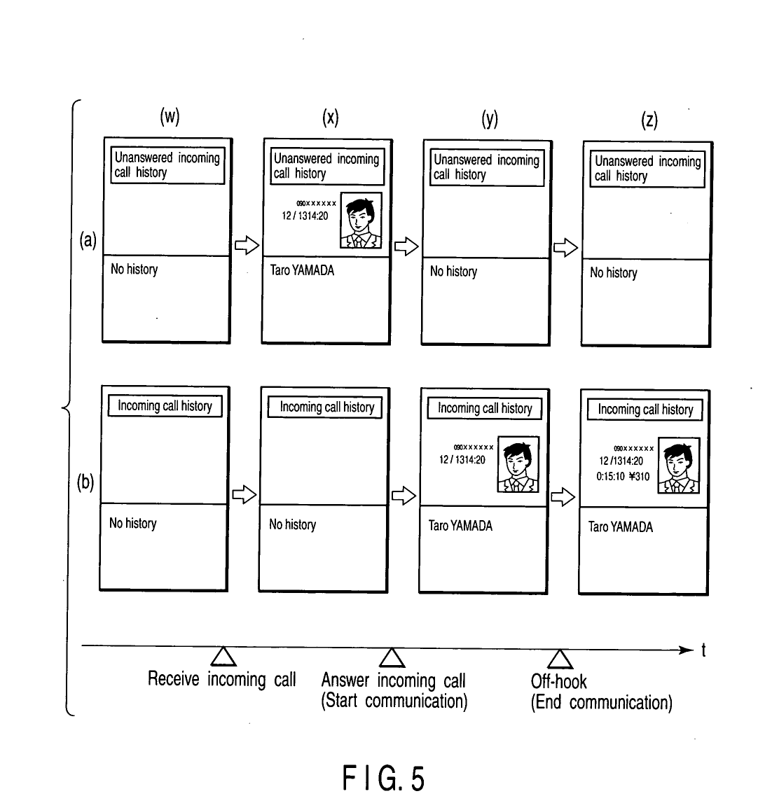

In this structure, when the conversation is ended, the conversation time and the conversation charged based thereon are stored in association with the incoming call history, as shown in FIG. 5, in step 21 of the processing shown in FIG. 2. The incomplete flag is deleted just when the conversation is ended. With this processing, too, the same advantage can be obtained.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal apparatus capable of making communications with a radio base station connected to a network, comprising:
time register unit configured to register time;
receiving unit configured to receive an incoming call signal from the radio base station;
caller detection unit configured to detect caller identification information in the incoming call signal received by the receiving unit;
incoming call time detection unit for detecting time when the incoming call has been received, in accordance with the time registered by the time register unit;
unanswered incoming call history storing unit configured to, if an incoming call is received, store the identification information detected by the caller detection unit and the time detected by the incoming call time detection unit as a history of an unanswered incoming call; and
incoming call history storing unit configured to, if conversation is started by answering the incoming call, store the identification information detected by the caller detection unit and the time detected by the incoming call time detection unit as a history of an answered incoming call.

2. The apparatus according to claim 1, further comprising history deleting unit configured to, if the conversation is started by answering the incoming call, delete the history corresponding to the incoming call, in the history stored by the unanswered incoming call history storing unit.

3. The apparatus according to claim 1, further comprising:
conversation time detection unit configured to detect for a conversation time in accordance with the time registered by the time register unit; and
conversation history storing unit configured to, if conversation is ended, store the identification information detected by the caller detection unit and the time detected by the conversation time detection unit as a history of conversation.

4. The apparatus according to claim 1, further comprising conversation time detection unit configured to detect for a conversation time in accordance with the time registered by the time register unit,
wherein if the conversation is ended, the incoming call history storing unit stores the identification information detected by the caller detection unit and the time detected by the conversation time detection unit as a history of an incoming call.

5. The apparatus according to claim 1, further comprising:
accepting unit configured to accept a request from a user;
display unit configured to display information; and
display control unit configured to, if the user's request is accepted by the accepting unit during the incoming call, display any one of the history stored by the unanswered incoming call history storing unit and the history stored by the incoming call history storing unit on the display unit.

6. The apparatus according to claim 1, further comprising:
accepting unit configured to accept a request from a user;
display unit configured to display information; and
display control unit configured to, if the user's request is accepted by the accepting unit during the conversation, displaying any one of the history stored by the unanswered incoming call history storing unit and the history stored by the incoming call history storing unit on the display unit.

7. A mobile radio terminal apparatus capable of making communications with a radio base station connected to a network, comprising:
accepting unit configured to accept a request from a user;
time register unit configured to register time;
receiving unit configured to receive an incoming call signal from the radio base station;
caller detection unit configured to detect caller identification information in the incoming call signal received by the receiving unit;
incoming call time detection unit configured to detect time if the incoming call has been received, in accordance with the time registered by the time register unit;
unanswered incoming call history storing unit configured to, if an incoming call is received, store the identification information detected by the caller detection unit, the time detected by the incoming call time detection unit and an identification flag, as a history of an unanswered incoming call;
history deleting unit configured to, if conversation is started by answering the incoming call, delete a history corresponding to the incoming call, in the history stored by the unanswered incoming call history storing unit;
incoming call history storing unit configured to, if conversation is started by answering the incoming call, store the identification information detected by the caller detection unit, the time detected by the incoming call time detection unit and the identification flag, as a history of an answered incoming call;
flag deleting unit configured to, if the conversation is ended, delete the identification flag in the history stored by the incoming call history storing unit;
detecting unit configured to, if the mobile radio terminal apparatus is started again, detect caller identification information to which the identification flag is added, in the history stored by the unanswered incoming call history storing unit and the history stored by the incoming call history storing unit; and
outgoing call unit configured to transmit an outgoing call based on the identification information detected by the detecting unit, in response to the user's request accepted by the accepting unit.

8. The apparatus according to claim 7, by further comprising:
conversation time detection unit configured to detect for a conversation time in accordance with the time registered by the time register unit; and
conversation history storing unit configured to, if conversation is ended, store the identification information detected by the caller detection unit and the time detected by the conversation time detection unit as a history of conversation.

9. The apparatus according to claim 7, further comprising conversation time detection unit configured to detect for a conversation time in accordance with the time registered by the time register unit,
wherein if the conversation is ended, the incoming call history storing unit stores the identification information detected by the caller detection unit and the time detected by the conversation time detection unit as a history of an incoming call.

10. The apparatus according to claim 7, further comprising:
accepting unit configured to accept a request from a user;
display unit configured to display information; and
display control unit configured to, if the user's request is accepted by the accepting unit during the incoming call, display any one of the history stored by the unanswered incoming call history storing unit and the history stored by the incoming call history storing unit on the display unit.

11. The apparatus according to claim 7, further comprising:
accepting unit configured to accept a request from a user;
display unit configured to display information; and
display control unit configured to, if the user's request is accepted by the accepting unit during the conversation, displaying any one of the history stored by the unanswered incoming call history storing unit and the history stored by the incoming call history storing unit on the display unit.
